(19) United States
(12) Patent Application Publication
(10) Pub. No.: US 2014/0173946 A1
(43) Pub. Date: Jun. 26, 2014

(54) ZERO-TURN UTILITY VEHICLE

(71) Applicant: BRIGGS & STRATTON CORPORATION, Wauwatosa, WI (US)

(72) Inventors: Samuel Gerrits, Milwaukee, WI (US); James Mast, Milwaukee, WI (US)

(73) Assignee: Briggs & Stratton Corporation, Wauwalosa, WI (US)

(21) Appl. No.: 13/722,897

(22) Filed: Dec. 20, 2012

(51) Int. Cl. B62D 11/12; E02F 3/28; E02F 3/76; A01D 34/64; E01H 5/04

(52) U.S. Cl. CPC B62D 11/12; A01D 34/64; E01H 5/045; E02F 3/76; E02F 3/28
USPC 37/248; 180/6.62; 56/14.7; 37/244; 172/811; 414/685; 15/21.1

(57) ABSTRACT

A zero-turn utility vehicle includes a frame, a pair of drive wheels disposed proximate to the front end of the frame, a rear wheel disposed proximate to the rear end of the frame, a prime mover supported by the frame above the drive wheels, the prime mover configured to power the drive wheels, a seat supported by the central structure, the seat disposed between the prime mover and the rear end, the seat configured to support a user facing towards the front end in a normal operating position, a pair of footrests located on opposite sides of the seat, a tool attachment coupled to the frame and powered by the prime mover, and user controls configured to operate the drive wheels, wherein each of the drive wheels may be operated independently with the user controls.

### BACKGROUND

The present disclosure relates generally to the field of outdoor power equipment. More specifically the present disclosure relates to riding lawn mowers.

Consumer riding lawn mowers can be generally categorized into two groups: traditional lawn tractor machines and zero-turn machines. Traditional lawn tractor machines are typically configured similar to an agricultural tractor, with a prime mover mounted at the front of the machine and the user seated above the drive wheels at the rear of the machine. Steering of such machines is achieved by pivoting the front, unpowered wheels. Zero-turn machines are typically configured with a prime mover mounted at the rear of the machine above the independently controlled drive wheels. The front wheels are unpowered casters and steering the machine is achieved by varying the relative speeds of the left and right drive wheels.

Both traditional lawn tractor machines and zero-turn machines may have a rotary mowing deck including one or more rotating blades configured to cut grass to a desired height. The mowing deck may be belly mounted (e.g., mounted between the front wheels and the rear wheels) or may be either front mounted (e.g., mounted at or in front of the front wheels) or rear mounted ((e.g., mounted at or in front of the rear wheels). Lawn tractors have a turning radius limited by the amount which the front wheels can be turned and may therefore have a relatively substantial turning radius. A front-mounted mower deck may be more easily positioned by a user thanks to a greater visibility to the operator compared to a belly mounted mower deck. However, a typical zero-turn machine with a front mounted mower deck can also require substantial space to rotate, as the total turning clearance includes the entire length of the machine from the drive wheels at the rear of the vehicle to the front edge of the front mounted mower deck. This can make it difficult to maneuver such a zero-turn machine in cramped environments, such as a residential yard.

While zero-turn lawn mowers are generally specialized machines that are not configured for use throughout the year (e.g., lawn mowing, snow removal, landscaping, etc.), lawn tractor machines may be configured to accept a wide variety of attachments to be used throughout the year. However, lawn tractors have limited maneuverability and lack zero-turn capabilities. Further, zero-turn lawn mowers are generally steered using a pair of levers, each of which control one side of the drive mechanism. While such controls allow a skilled operator to effectively steer a zero-turn lawn mower, they can be difficult to use for an operator that is more familiar with the steering wheel or handlebar mechanisms of other vehicles (e.g., automobiles, motorcycles, bicycles, personal watercraft, ATVs, etc.).

### SUMMARY

One embodiment of the invention relates to a zero-turn utility vehicle including a frame having a front end, a rear end, a right side, a left side, and a central structure located between the right side and the left side, a pair of drive wheels disposed proximate to the front end of the frame, each drive wheel having a drive mechanism, the first drive wheel located on the left side of the frame and the second drive wheel located on the right side of the frame, a rear wheel disposed proximate to the rear end of the frame, a prime mover supported by the frame above the drive wheels, the prime mover configured to power the drive wheels via the drive mechanisms, a seat supported by the central structure, the seat disposed between the prime mover and the rear end, the seat configured to support a user facing towards the front end in a normal operating position, a pair of footrests located on opposite sides of the seat, each of the footrests configured to support one of the user's feet, the footrests separated from one another by the central structure so that the first footrest is located on the right side of the frame and the second footrest is located on the left side of the frame, a tool attachment coupled to the frame and powered by the prime mover, and user controls configured to operate the drive wheels, wherein the user faces the user controls in the normal operating position, wherein each of the drive wheels may be operated independently with the user controls.

Another embodiment of the invention relates to a zero-turn utility vehicle including a frame having a front end, a rear end, a right side, and a left side, a pair of drive wheels disposed proximate to the front end of the frame, each drive wheel having a drive mechanism, the first drive wheel located on the left side of the frame and the second drive wheel located on the right side of the frame, a rear wheel disposed proximate to the rear end of the frame, a prime mover supported by the frame above the drive wheels, the prime mover configured to power the drive wheels via the drive mechanisms, a seat supported by the frame, the seat disposed between the prime mover and the rear end, the seat fixed in a single orientation to support a user facing towards the front end in a normal operating position, a front mount located proximate the front end and forward of the drive wheels, the front mount configured to receive a tool attachment to be powered by the prime mover, a mid mount located between the drive wheels and the rear wheel and rearward of the prime mover, the mid mount configured to receive the tool attachment, and user controls configured to operate the drive wheels, wherein the user faces the user controls in the normal operating position, wherein each of the drive wheels may be operated independently with the user controls.

Still another embodiment of the invention relates to a zero-turn utility vehicle including a frame having a first end and a second end, two drive wheels disposed proximate to the first end of the frame, a third wheel disposed proximate to the second end of the frame, a prime mover supported proximate the first end of the frame, the prime mover configured to power the drive wheels, a handlebar mechanism configured to operate the drive wheels, the handlebar mechanism rotatable about an axis from a neutral position into a first rotation zone and a second rotation zone, and a controller receiving an input from the handlebar mechanism, the controller coupled to the drive wheels, wherein the controller directs the drive wheels to rotate such that the vehicle turns about a point outboard from the first drive wheel when the handlebar mechanism is in the first rotation zone, and wherein the controller directs the drive wheels to rotate such that the vehicle turns about a point between the first drive wheel and the second drive wheel when the handlebar mechanism is in the second rotation zone.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures.

FIG. 1 is an isometric view of a zero-turn utility vehicle, in accordance with an exemplary embodiment.

FIG. 2 is a side view of the a zero-turn utility vehicle of FIG. 1.

FIG. 3 is a front view of the a zero-turn utility vehicle of FIG. 1.

FIG. 4 is a top view of the a zero-turn utility vehicle of FIG. 1.

FIG. 5 is an isometric view of the a zero-turn utility vehicle of FIG. 1, with the outer housing removed.

FIG. 6 is a perspective view of the controls for the zero-turn utility vehicle of FIG. 1, in accordance with an exemplary embodiment.

FIG. 7 is a schematic top view of the controls for the zero-turn utility vehicle of FIG. 1, in accordance with another exemplary embodiment.

FIG. 8A is a schematic diagram of the steering mechanism for the controls of FIG. 7 in a neutral position, in accordance with an exemplary embodiment.

FIG. 8B is a schematic diagram of the steering mechanism for the controls of FIG. 7 in a first rotation zone, in accordance with an exemplary embodiment.

FIG. 8C is a schematic diagram of the steering mechanism for the controls of FIG. 7 in a second rotation zone, in accordance with an exemplary embodiment.

FIG. 9 is an isometric view of the a zero-turn utility vehicle of FIG. 1 with a belly-mount mowing deck, in accordance with an exemplary embodiment.

FIG. 10 is an isometric view of the a zero-turn utility vehicle of FIG. 1 with a front-mount mowing deck, in accordance with an exemplary embodiment.

FIG. 11 is an isometric view of the a zero-turn utility vehicle of FIG. 1 with a front-mount single-stage snow thrower, in accordance with an exemplary embodiment.

FIG. 12 is an isometric view of the a zero-turn utility vehicle of FIG. 1 with a front-mount two-stage snow thrower, in accordance with an exemplary embodiment.

FIG. 13 is a side view of the a zero-turn utility vehicle of FIG. 1 with a front-mount blade, in accordance with an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

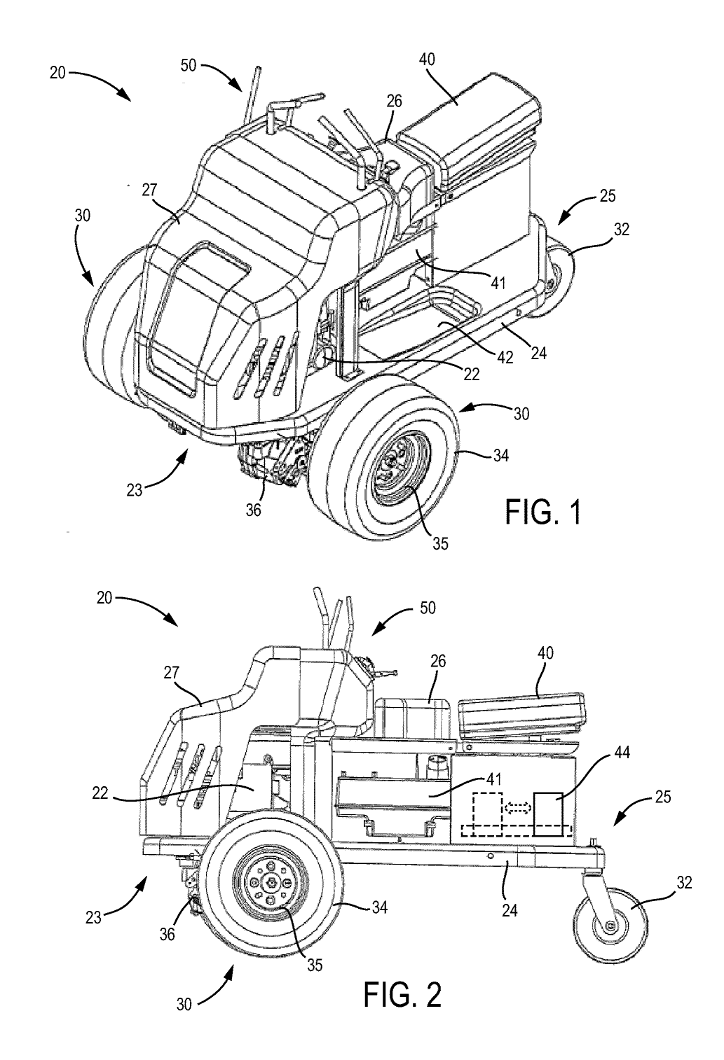

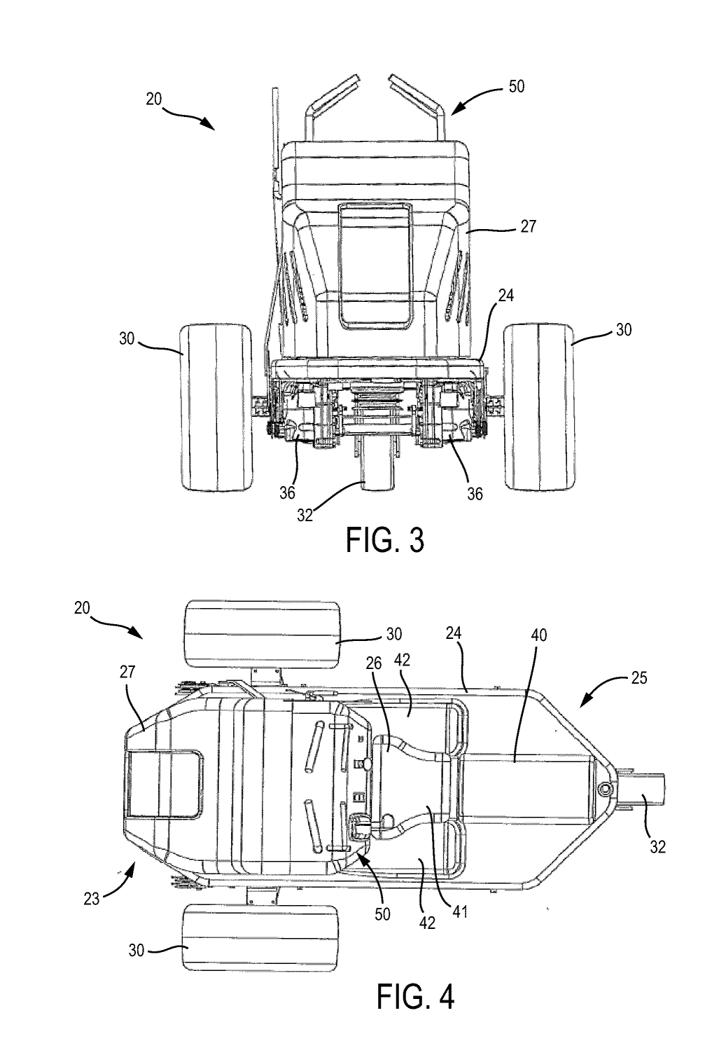

Referring to FIGS. 1-5, a utility vehicle 20 (e.g., riding lawn mower, lawn tractor, etc.) includes an prime mover 22 coupled to a frame 24. The utility vehicle 20 is configured to be utilized for a variety of tasks throughout the year through the use of multiple components or attachments that are coupled to the bottom of the frame 24 (e.g., a belly mount, bottom mount, middle mount, etc.) or to the front of the frame 24 (e.g., a forward mount, front mount, etc.). More than one attachments may be coupled to the frame 24 at a belly mount position and/or a front mount position, as described in more detail below. The vehicle 20 is intended to be a maneuverable, zero-turn vehicle.

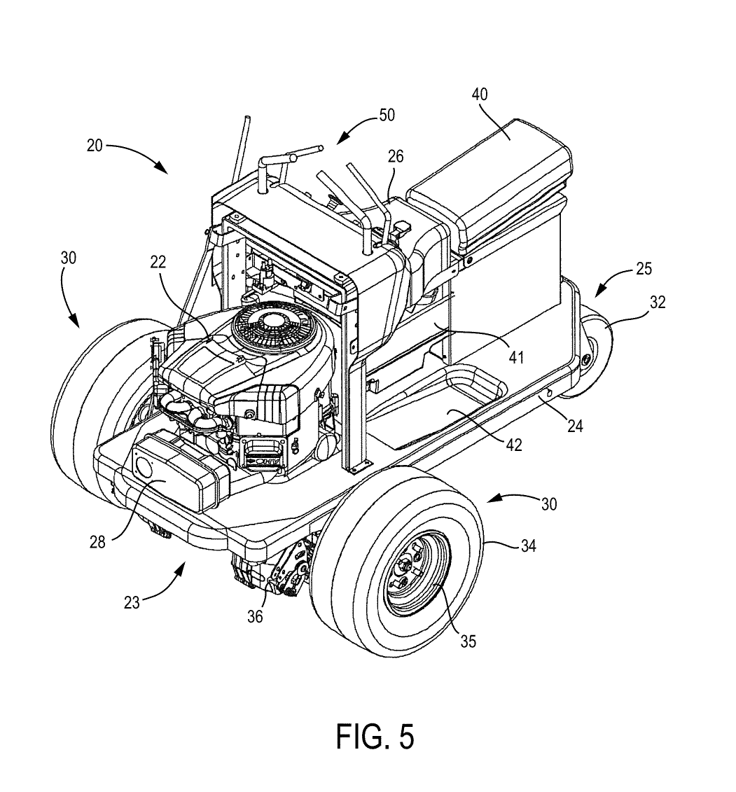

According to an exemplary embodiment, the prime mover 22 may be a V-twin, four cycle (i.e., four piston strokes per cycle) gasoline engine. The prime mover 22 may be started manually (e.g., with a pull cord), or via another device such as a starter motor. The prime mover 22 may consume fuel contained within a fuel tank 26 and expel exhaust through a muffler 28 (see FIG. 5). In other contemplated embodiments, the prime mover 22 may be a two-stroke engine. The prime mover 22 may be a single cylinder engine or may have more than one cylinder. The engine may be oriented such that the drive shaft is horizontal, vertical, or angled. In other embodiments, the prime mover 22 may be configured to consume other fuels, such as diesel fuel, liquid propane, fuel oil, natural gas, alcohol, kerosene, or hydrogen. In still other exemplary embodiments, the prime mover may be an electric motor and draw electrical power from an on-board electrical storage device (e.g., a battery pack, fuel cell, etc.). Various components of the vehicle 20, such as the prime mover 22, the muffler 28, may be housed within a hood 27 (e.g., enclosure, cover, cowl, etc.).

The vehicle 20 further includes front wheels 30 and one or more rear wheels 32 coupled to the underside of the frame 24. The front wheels 30 are generally aligned with the prime mover 22 at the forward end 23 of the frame 24 such that the moment created by the mass of the prime mover 22 is minimized and the weight vector of the prime mover 22 passes through or near to the contact surface between the wheels 30 and the ground, thereby increasing the traction of the wheels 30. In other contemplated embodiments, the vehicle 20 may be propelled by treads or other rotating or moving elements in place of wheels.

Each of the front wheels 30 (e.g., drive wheels) include a tire 34 on a rim 35 that is rotatably coupled to the forward end 23 of the frame 24 on an transaxle 36 supported by bearings. The front wheels 30 propel the vehicle 20 and steer the vehicle 20 by varying the relative speed between the two front wheels 30. For example, by keeping one front wheel 30 stationary and rotating the other front wheel 30, the vehicle 20 may turn about the stationary wheel 30. A tighter, “zero radius” turn may be achieved by rotating one front wheel 30 forward and the other front wheel 30 backward, causing the vehicle to rotate about a point between the two front wheels 30.

According to an exemplary embodiment, the vehicle 20 may utilize different tires 34 for different tasks. For example, the tires 34 may be have a less-aggressive tread if the vehicle 20 is utilized for basic use on grass, such as for lawn mowing, where a relatively small amount of traction is needed. In other embodiments, the tires 34 may have a more aggressive utility tread, such as a knobby tread found on an all-terrain vehicle tire. In other embodiments, the tires 34 may have an even more aggressive tread, such as found on agricultural tractors. If the vehicle 20 is utilized in snowy or icy environments, the tires 34 may be equipped with snow chains or studs to further increase traction.

The front wheels 30 may each be driven by an independent motor to allow increased maneuverability of the vehicle 20. According to an exemplary embodiment, the motors may be low-speed, high-torque hydraulic motors that are turned by hydraulic fluid provided by a hydraulic pump powered by the prime mover 22. The hydraulic pump may be coupled to the output shaft of the prime mover 22 via an intermediate transmission device such as a belt. Each motor is coupled to the respective wheel 30 through the transaxle 36.

The rear wheel 32 is coupled to the rear end 25 of the frame 24. The rear wheel 32 is a non-powered caster-type wheel that is configured to rotate (e.g., about a horizontal axis of rotation) and turn (e.g., about a vertical axis of rotation) freely. As shown in the figures, in one embodiment, the vehicle 20 may include a single rear wheel 32 located along the centerline of the vehicle 20 such that the front wheels 30 and the rear wheel 32 form a triangular footprint. In other exemplary embodiments, the vehicle 20 may include more than one rear wheel 32 (e.g., two rear wheels 32 provided at the rear corners of the frame 24).

A seat 40 is mounted to the a central structure 41 of the frame 24 rearward from the prime mover 22 and the front wheels 30. The central structure 41 is located between the left side and the right side of the frame 24. The seat 40 is configured to support the operator of the vehicle 20 in a position that allows the operator to manipulate the controls 50 described in more detail below. In a normal operating position, the user faces towards the front wheels 30. The seat 40 may be fixed relative to the frame or may be adjustable in a vertical direction, in a horizontal direction (e.g., front to back or side to side), or about an axis (e.g., a forward or backward tilt) to allow the operator to adjust the seating position. The seat 40 may be coupled to the frame 24 with a hinged connection which allows the seat 40 to be pivoted upward to access components of the vehicle 20 below the seat (e.g., the fuel tank 26, a battery, etc.). The seat 40 is fixed at a single orientation. That is, the seat 40 cannot be swiveled, pivoted, or otherwise moved so that a seated user faces the front of the vehicle 20 (i.e., toward the drive wheels 30) with the seat 40 in one orientation and the seated user faces the rear of the vehicle 20 (i.e. toward the rear wheel 32) with the seat 40 in a second orientation. The seat 40 is always oriented so that a seated user faces the front of the vehicle 20.

Footrests 42 (e.g., pads, indentations, hollows, detents, etc.) may be formed in the frame 24 on either side of the seat 40. The footrests 42 are physically separated from one another by the central structure 41. The footrests 42 provide a visual indication for the placement of the operator's feet. The footrests 42 may be equipped with features such as a raised pattern (e.g., a diamond plate pattern) or an anti-slip material to increase the traction between the operator's feet and the surface of the frame 24. In other embodiments, the frame 24 may not include indentations and a raised pattern, anti-slip material, or other appropriate footrest design may be provided as footrests 42 on either side of the seat 40.

In one embodiment, as shown in the figures, the seat 40 may be shaped similar to a motorcycle, snowmobile, or personal watercraft seat such that the seat 40 is straddled by the operator. The seat 40 may have a padded, resilient surface or may have a relatively firm surface (e.g., a rigid molded plastic). The seat 40 may be contoured to a shape generally conforming to the shape of the operator to increase the comfort of the operator when operating the vehicle 20. The seat 40 may, in some embodiments, include a generally vertical back rest. In other embodiments, the seat 40 may be a bucket seat or may include arm rests. In other contemplated embodiments, the seat 40 may include an internal heating or cooling element (e.g., a resistive heating element, a channel for the circulation of a heat transfer fluid) to increase the comfort of the operator in a variety of operating conditions, increasing the year-round utility of the vehicle 20.

The seat 40 may be pressure sensitive (e.g., coupled to a pressure-sensitive or spring-loaded switch) such that the presence of an operator sitting on the seat 40 may be detected. For example, the vehicle 20 may be configured to disengage the prime mover 22 or an accessory or attachment coupled to the vehicle 20 if the operator gets up off of the seat 40. In other exemplary embodiments, the presence of an operator on the seat may be otherwise detected, such as with a laser sensor, an infrared sensor, etc.

As shown schematically in FIG. 2, in some embodiments, a moveable counterweight 44 may be provided in the central structure of the frame 24, under the seat 40. The counterweight 44 is configured to be movable forward and rearward (e.g., along a rail, into discreet slots or sockets, etc.) to move the center of gravity of the vehicle 20 front to back. For example, if a heavy attachment is coupled to the front of the vehicle 20, the counterweight 44 may be moved rearward. If no attachment or a lightweight attachment is coupled to the front of the vehicle 20 or it the vehicle 20 is used to tow a trailer or another implement, the counterweight 44 may instead be moved forward. The movement of the center of gravity of the vehicle 20 via the movement of the counterweight 44 is intended to adjust the vehicle balance and drive wheel traction. In other embodiments, the movable counterweight 44 is located at other suitable positions on the vehicle 20.

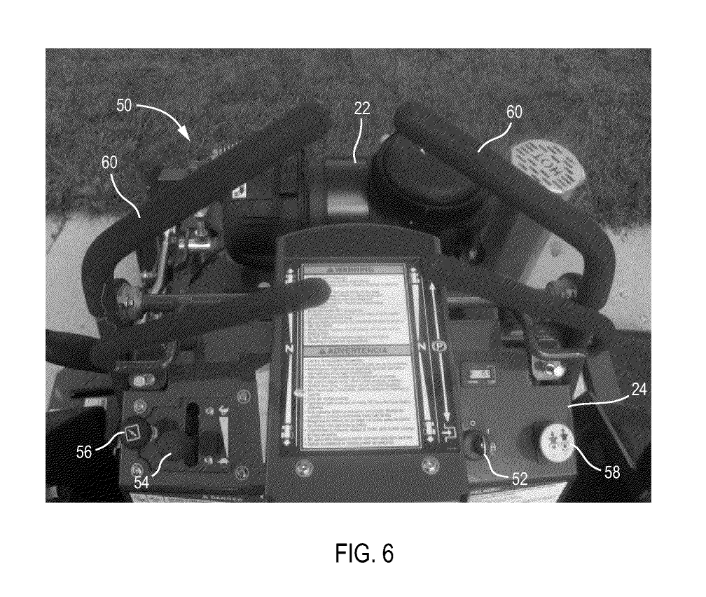

Referring now to FIGS. 6-8, the operator controls 50 of the vehicle 20 are shown according to several exemplary embodiments. In some embodiments, the controls 50 includes various mechanisms disposed on a panel or dash 51 located on the frame 24 in front of an operator sitting on the seat 40. The controls 50 may include, for example, an on/off switch 52, a throttle control 54, a choke control 56, and a power takeoff (PTO) control 58. The controls 50 may also include devices to operate other attachments coupled to the vehicle 20, as will be described in more detail below and a display screen 55. The controls 50 further include a steering mechanism. As such, while seated in the seat 40, the operator may activate the vehicle 20, control the direction and speed of the vehicle 20, engage the blade or other accessory or attachment, and otherwise operate the vehicle 20 by way of the controls 50.

The throttle control 54 may be a three-position lever with a start position, an idle position, and an operate position. The throttle control may be, for example, a switch, a dial, a lever, or any other suitable mechanism. The vehicle 20 may be configured such that the throttle control 54 must be in the start position to start the prime mover 22. With the throttle control 54 in the start position, the prime mover 22 may operate at a higher RPM. The vehicle 20 may be configured such that the throttle control 54 must be in the idle position to engage a feature such as a parking brake. Placing the throttle control 54 in the idle position may disengage or bypass an operator detection sensor in the seat 40 to allow an operator of the vehicle to get off of the vehicle 20 if certain criteria are met (e.g. all attachments are deactivated, the traction drive is disconnected, the brake is engaged, etc.). With the throttle control 54 in the operate position, the RPM of the prime mover may adapt automatically to the operation of the vehicle 20. For example, the prime mover 22 may remain at a relatively low idling RPM until the vehicle 20 begins to move forward and then ramp up to a first RPM level (e.g., approximately 30% maximum). The prime mover 22 may increase RPMs further when an accessory is activated and a PTO is engaged (e.g., approximately 50% maximum). The prime mover 22 may increase RPMs further when a heavy load is sensed by an attachment, such as a heavy cutting load by a mowing deck, a heavy snow load by a snowthrower, or a heavy payload by a bucket or dump box.

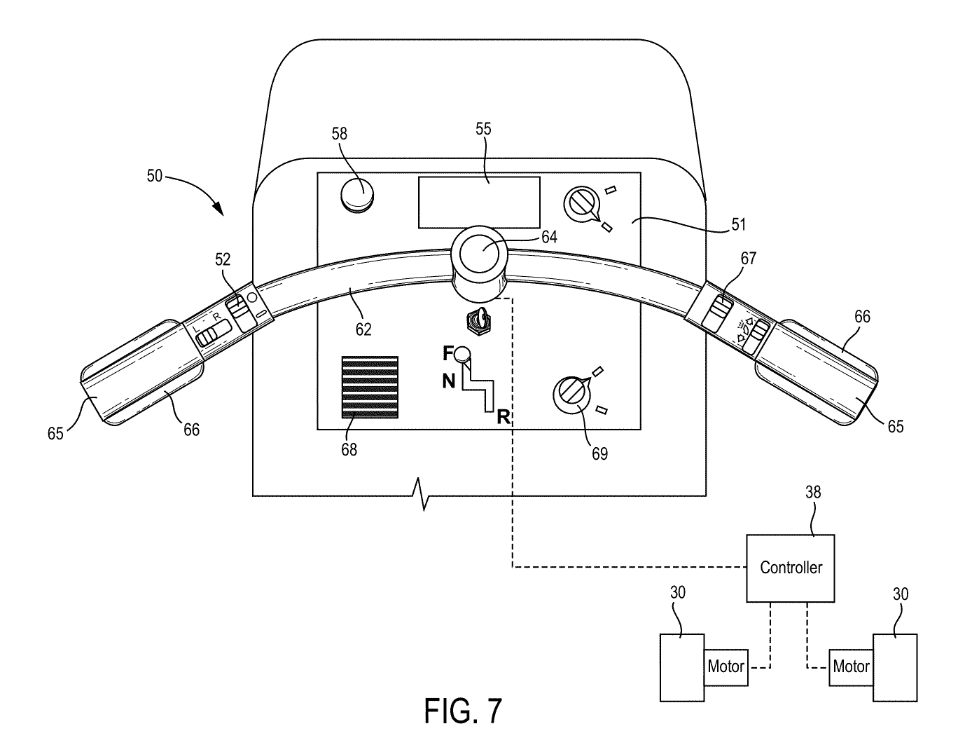

Referring to FIG. 6, in one embodiment, the steering mechanism may be similar to a conventional zero-turn lawn mower steering mechanism and include a pair of levers 60, one provided on either side of the vehicle 20. In one embodiment, the left and right levers 60 may each be directly coupled to the speed controls for the motor of the respective front wheel 30 with mechanical linkages. In another exemplary embodiment, the levers 60 may not be directly coupled to the motors for the front wheels 30. Instead, the movement of the levers 60 may be detected and translated to corresponding adjustments to the front wheels 30 by a controller 38 in a drive-by-wire system (e.g., the system shown in and described with reference to FIG. 7).

The operator may control the direction and speed of the vehicle 20 in a manner similar to conventional zero-turn lawn mowers. For example, the operator may cause the vehicle 20 to move forward by pushing both levers 60 forward, move in reverse by pulling both levers 60 backward. The operator can also turn the vehicle by moving one lever 60 forward and the other lever 60 backward or by leaving one lever 60 in a neutral position and moving the other lever 60 either forward or backward. The rotational speed of the motor may be proportional to the amount the respective lever 60 is moved either forward or backward.

Referring now to FIG. 7, in another embodiment, the steering mechanism may include a handlebar 62 rotatable about a central pivot point 64. The handlebar 62 may be communicate with a controller 38 that operates the front wheels 30 based on the position of the handlebar 62. The various controls (e.g., the throttle control 54 and the PTO control 58, etc.) and the display 55 may be provided either within easy reach or view of the operator on the dash 51 or on the handlebar 62 itself. The ends of the handlebar 62 include hand grips 65 that are grasped by the operator. The hand grips 65 may include switches 66 (e.g., pressure-sensitive switches, capacitive switches, etc.) that are activated when the operator grasps the handlebar 62. According to an exemplary embodiment, the throttle for the prime mover 22 may be controlled by rotating one or both of the hand grips 65 relative to the main body of the handlebar 62.

While the operator is grasping the hand grips 85, additional handlebar controls 67 may be manipulated with the thumbs. The handlebar controls 67 may be related to the operation of the prime mover 22, other systems on the vehicle 20, or systems related to an attachment coupled to the vehicle (e.g., a deflector up/down control or a chute rotation control for a snow thrower attachment). Additional dash controls 69 may be provided on the dash 51. The dash controls 69 may be utilized to control the operation of the prime mover 22, other systems on the vehicle 20, or systems related to an attachment coupled to the vehicle 20 that may be or are preferably adjusted while the vehicle is not in motion. For example, dash controls 69 may include controls for a reverse mowing option (RMO) system, head lights, the drivetrain (e.g., a forward/neutral/reverse switch), etc. The handlebar controls 67 and the dash controls 69 may be adaptive and may serve different functions depending on the attachment(s) coupled to the vehicle 20.

The dash 51 may include other features, such as a hand warmer 68 to increase the usability of the vehicle 20 in a variety of operating environments. The steering mechanism may include heated portions (e.g., heated hand grips) to increase the comfort of the operator and the utility of the vehicle 20 in colder operating environments.

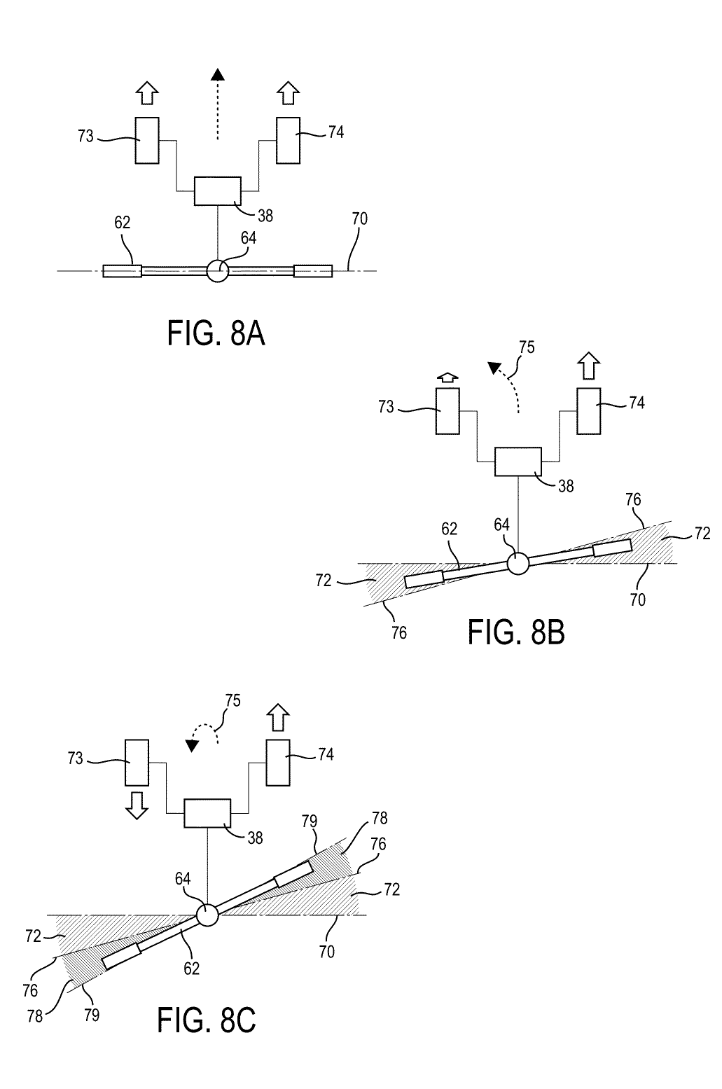

Referring to FIGS. 8A-8C, the operator may steer the vehicle 20 by turning the handlebar 62 about the pivot point 64. While the handlebar 62 may be ergonomically curved, as shown in FIG. 7, it is depicted as a straight member in FIGS. 8A-8C for simplicity. The position of the handlebar 62 may be detected by the controller 38 and used to operate the front wheels to steer the vehicle 20. The handlebar 62 may be configured to control the operation of the front wheels in different ways depending on the angle to which the handlebar 62 is rotated about a central pivot point. As shown in FIG. 8A, the handlebar 62 may have a neutral position 70 in which the handlebar 62 is perpendicular to the forward direction of travel. This neutral position 70 may be considered to have a rotational angle of 0 degrees. The handlebar 62 may be biased (e.g., spring-loaded) towards the neutral position such that it returns to the neutral position 70 when not being acted upon by the operator of the vehicle 20. The steering mechanism may include a detent at the neutral position 70 to provide a physical indication that the handlebar 62 is in the neutral position 70. With the handlebar 62 in the neutral position 70, the controller 38 may monitor and adjust the rotational speeds of the front wheels to maintain a straight forward (or rearward) driving path for the vehicle 20.

By pushing one end of the handlebar 62 forward and/or pulling the other end backward, the operator may rotate the handlebar 62 either left (as shown in FIG. 8B) or right from the neutral position 70 into a first rotational range 72. The first rotational range 72 is defined as a range between the neutral position 70 and a first upper bound 76. According to an exemplary embodiment, the upper bound 76 of the first rotational range 72 is approximately 10 degrees from the neutral position 70. The steering mechanism may include a detent at the upper bound 76 to provide an operator of the vehicle 20 a physical indication of when the handlebar 62 is at the first upper bound 76 of the first rotational range 72.

With the handlebar 62 in the first rotational range, the vehicle 20 is directed to turn in the indicated direction by slowing or stopping the forward rotation of a first front wheel 73 (e.g., the inside wheel) and rotating the second front wheel 74 (e.g., the outside wheel). The vehicle 20 then turns in the direction of the slowed or stopped first wheel 73 along a curved path, indicated by a dashed line 75 in FIGS. 8B and 8C, so that the vehicle 20 turns about a point outboard from the first drive wheel 73. The path of the relatively shallow turn 75 of the vehicle 20 corresponding to the first rotational range 72 has a turning radius that ranges from a maximum, near-infinite value (e.g., straight travel) when the handlebar 62 is near the neutral position 70, to a minimum value when the handlebar 62 is rotated to the first upper bound 76 defining the limit of the first rotational range 72. The minimum radius of the turn 75 may correspond to a scenario in which the first wheel 73 is held stationary and the second wheel 74 moves forward. The vehicle 20 rotates about the first wheel 73 and the minimum turning radius may correspond to the front axle track of the vehicle 20 (e.g., the distance between the front wheels). According to an exemplary embodiment, the vehicle 20 has a minimum turning radius of approximately 18 inches when the handlebar 62 is at the first upper bound 76.

As shown in FIG. 8C, the handlebar 62 may be moved beyond the first rotational range 72 (e.g., past a detent indicating the first upper bound 76) and into the second rotational range 78. With the handlebar 62 in the second rotational range 78, the vehicle 20 is directed to turn in the indicated direction with a “zero-radius” turn. The first wheel 73, which is stopped when the handlebar 62 is at the position corresponding to first the upper bound 76, is directed by the controller 38 to rotate backward in a direction opposite of the rotation of the second wheel 74. The vehicle 20 then turns about a point between the first wheel 73 and the second wheel 74. When the first wheel 73 and the second wheel 74 are rotating at the same speed but in opposite directions, the vehicle rotates about a point equidistant from the first wheel 73 and the second wheel 74, generally at the centerline of the vehicle 20. The second rotational range 78 may be limited by a second upper bound 79. According to an exemplary embodiment, the second upper bound 79 is approximately 10 degrees from the first upper bound 76 and 20 degrees from the neutral position 70. At the second upper bound 79, the controller 38 may limit the wheels 73 and 74 to a maximum rotational speed. In an exemplary embodiment, the first wheel 73 may move rearward at approximately 8 mph and the second wheel 74 may move forward at approximately 8 mph when the handlebar 32 is at the second upper bound 79.

The steering mechanism including the handle bar 62 therefore provides an operator of the vehicle 20 with an intuitive manner of making a zero radius turn that may be easier to learn than using a conventional zero-turn lawn mower steering mechanism including two levers. Instead, using the handlebar 62, the operator may first initiate a relatively shallow turn by rotating the handlebar 62 into the first range 72 before initiating a zero radius turn by rotating the handlebar 62 further into the second range 78.

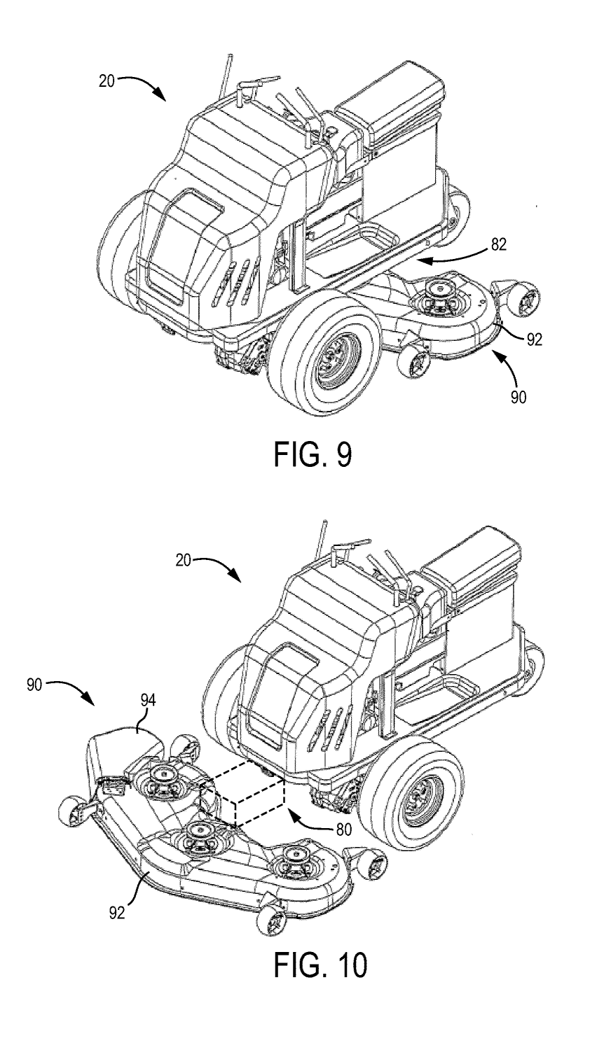

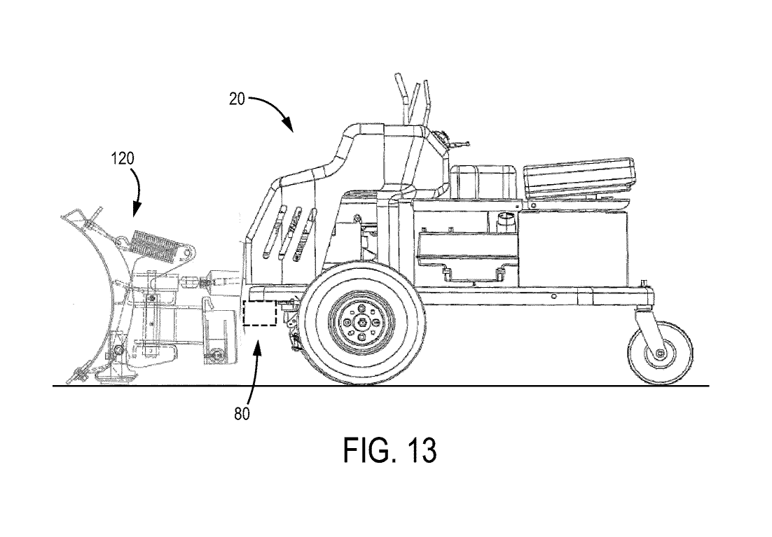

Referring now to FIGS. 9-13, the vehicle 20 is equipped to receive a wide variety of tool attachments, referred to generally as “attachments,” at several different mounting locations. As shown in general, the attachments may be coupled to the vehicle 20 via a front mount 80 (shown in FIG. 10) forward of the front wheels 30 at the front end of the vehicle 20 or a mid or belly mount 82 (shown in FIG. 9) rearward of the front wheels 30 between the front wheels 30 and the rear wheel 32. The front mount 80 and the belly mount 82 mechanisms may be similar to front mount and belly mount systems on conventional lawn tractors. The front mount 80 and the belly mount 82 are configured to be capable of quickly connecting and disconnecting an attachment and the vehicle 20. The attachment may be selectively powered by the prime mover 22 through a PTO (e.g., an electric PTO) engaged and disengaged by the operator using the controls 50. According to an exemplary embodiment, the attachment may be configured to be a powered attachment that operates at a generally constant velocity.

Both the front mount 80 and the belly mount 82 may be equipped with a lift mechanism to adjust the position of an attachment. The lift mechanism may be a hydraulic mechanism (e.g., a hydraulic actuator), an electric mechanism (e.g., an electric motor), or a manually operated mechanical linkage. The lift mechanisms may be operated by controls that may be located on the dash 51, on the steering mechanism (e.g., levers 60, handlebar 62), or elsewhere on the vehicle 20.

Because the vehicle 20 is steered by the front wheels 30 and turns about a point aligned with the front wheels 30, locating the attachment near to the front wheels 30 can increase the precision with which the attachment may be positioned by steering the vehicle 20. Further, by locating the attachment near to the front wheels 30, the total turning radius of the vehicle 20 (e.g., the distance between the point about which the vehicle 20 turns and the most distant portion of the vehicle 20) is minimized.

As shown in FIGS. 9-10, in one embodiment, the attachment may be a mowing deck 90. The deck 90 includes a skirt 92 at least partially surrounding the mower blades and a chute 94 through which grass clippings exit the skirt 92. Within the skirt 92, one or more mower blades (e.g., three) may be simultaneously run at high speeds to trim a swath of grass. The blades of the mowing deck 90 may be mechanically coupled to a power takeoff of the prime mover 22. For example, the front mount 80 may include a power transfer device and the blades of the mowing deck 90 may receive power through the front mount 80 (FIG. 10). In one exemplary embodiment, the front mount 80 may include a telescoping universal joint that is coupled to the mowing deck 90. In another exemplary embodiment, the front mount 80 may include a PTO mechanism that is coupled to the mowing deck 90 with a cone-type interface. If the mowing deck 90 is coupled to the belly mount 82, the blades may be other wise powered, such as by a belt that couples the blades to an output shaft of the prime mover 22 (FIG. 9).

However, in other contemplated embodiments two or more motors may be coupled to a vehicle DC bus and may be used in combination to simultaneously power the mower blade(s)—such as two, three, or four electric motors coupled to a common transmission that then distributes the aggregate mechanical energy provided by the motors to the mower blade(s). In another contemplated embodiment, the blades of the mowing deck 90 may be powered by one or more hydraulic motor(s) coupled to the hydraulic system of the vehicle 20.

One or more additional attachments may be coupled to the vehicle 20 to enhance the operation of the mowing deck 90. For example, a rear-mounted bagger or a mulching attachment may be connected to the chute 94 of the mowing deck 90 to redirect the grass clippings either into a bag or other container or back under the skirt 92 into the path of the blades.

While the mowing deck 90 is shown in FIGS. 9 and 10 as a rotary blade mowing deck, in other contemplated embodiments, the mowing deck may be another type of mowing deck, such as a reel mower (e.g. with one attachment coupled to the front mount and two attachments coupled to the belly mounted to the outside of the frame), a flail-type mower, a string trimmer, an edger, etc.

In still other embodiments, another type of lawn care or landscaping attachment may be coupled to the vehicle 20 either at the front mount 80 or the belly mount 82, such as a fertilizer, an aerator, a dethatcher, a trencher, a cultivator, or any other attachment that may be coupled to a conventional lawn tractor. A device such as a sun shade canopy may be coupled to the vehicle 20 to increase the comfort of the operator in warmer sunny operating environments.

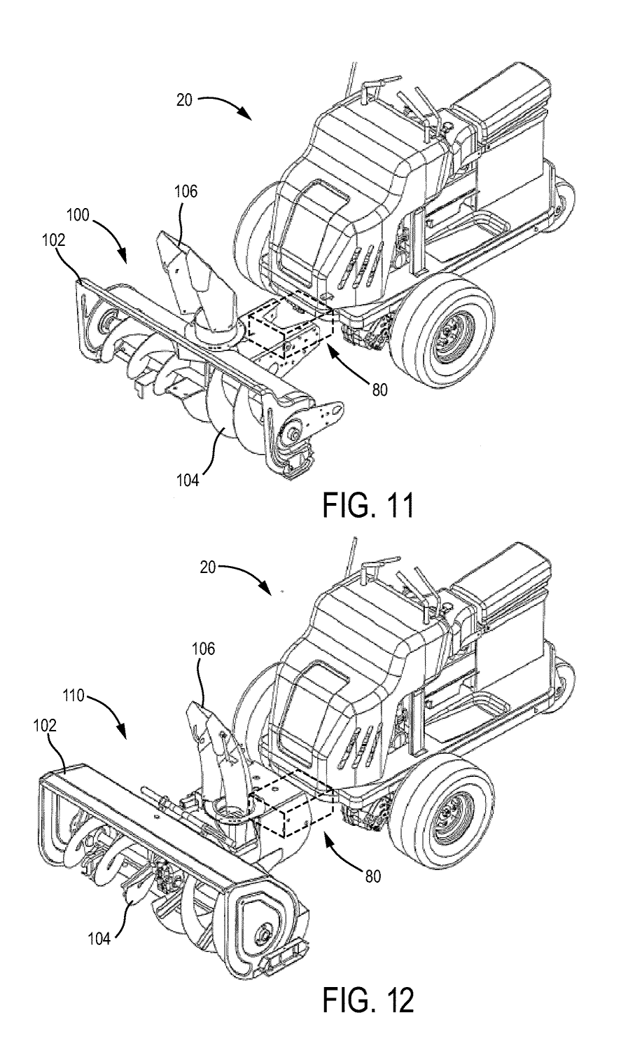

A warmer weather attachment such as a mowing deck 90 may be replaced with another attachment as the weather becomes colder to increase the utility of the vehicle 20 such that it may be used throughout the year. The attachment may be a device utilized in colder operating environments, such as a single-stage snowthrower 100 (see FIG. 11) or a dual-stage snowthrower 110 (see FIG. 12). The snowthrower 100, 110 includes a housing 102 and an auger or impeller 104 rotating within the housing 102 as the snowthrower 100, 110 is moved along a chosen path by the operator of the vehicle 20. Snow gathered and propelled by the auger 104 is directed away from the vehicle 20 through a chute 106. Similar to the mowing deck 90, the snowthrower 100, 110 is coupled to the vehicle and powered by the prime mover 22 through the front mount 80. The position of the chute 106 (e.g., the rotational position, angle, etc.) may be manipulated by the operator of the vehicle 20 using the controls 50.

In other embodiments, another type of snow removal attachment may be coupled to the vehicle 20, such as a snow blade 120 (FIG. 11), or a front-mounted rotary broom. A device such as a snow cab may be coupled to the vehicle 20 to increase the comfort of the operator in colder operating environment. Because the snow removal attachments are generally coupled to the front mount 80, a mowing deck 90 coupled to the belly mount 82 (not shown) may be removed or may be left connected to the vehicle 20 to provide a counterbalance to the front-mounted attachment.

In other contemplated embodiments, the vehicle 20 may be configured to receive many other attachments at either the front mount 80 or the belly mount 82. For example, a blower, a rotary broom, or vacuum attachment may be coupled to the front mount 80 or the belly mount 82. A variety of earthmoving attachments may be coupled to the vehicle 20, such as a dozer blade, a front end loader bucket, or a front mounted dump box, allowing the vehicle 20 to be utilized to move dirt, gravel, or other bulk materials.

The utility vehicle 20 is generally more compact, with a smaller footprint than that of a comparable conventional lawn tractor or zero-turn lawnmower. The utility vehicle 20 is capable of being connected to a wide variety of attachments, increasing its usefulness throughout the year. The utility vehicle 20 is capable of performing zero radius turns similar to a zero-turn lawnmower. However, the utilization of the front wheels 30 to drive the vehicle 20 minimizes the distance between the drive/steering wheels and an attachment coupled to the front mount 80 or the belly mount 82 and the overall turning radius of the vehicle. The utility vehicle 20 is therefore more maneuverable in confined spaces. Further, the steering mechanism including the handlebar 62 provides a manner for an operator to initiate a zero radius turn for the vehicle 20 in a manner that may be more intuitive than with the dual levers found on conventional zero-turn lawnmowers.

The construction and arrangements of the utility vehicle, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. Other substitutions, modifications, changes and omissions may also be made in the design, operating conditions and arrangement of the various exemplary embodiments without departing from the scope of the present invention.

What is claimed is:

1. A zero-turn utility vehicle, comprising:
a frame having a front end, a rear end, a right side, a left side, and a central structure located between the right side and the left side;
a pair of drive wheels disposed proximate to the front end of the frame, each drive wheel having a drive mechanism, the first drive wheel located on the left side of the frame and the second drive wheel located on the right side of the frame;
a rear wheel disposed proximate to the rear end of the frame;
a prime mover supported by the frame above the drive wheels, the prime mover configured to power the drive wheels via the drive mechanisms;
a seat supported by the central structure, the seat disposed between the prime mover and the rear end, the seat configured to support a user facing towards the front end in a normal operating position;
a pair of footrests located on opposite sides of the seat, each of the footrests configured to support one of the user's feet, the footrests separated from one another by the central structure so that the first footrest is located on the right side of the frame and the second footrest is located on the left side of the frame;
a tool attachment coupled to the frame and powered by the prime mover; and
user controls configured to operate the drive wheels, wherein the user faces the user controls in the normal operating position;
wherein each of the drive wheels may be operated independently with the user controls.

2. The zero-turn utility vehicle of claim 1, wherein the tool attachment is coupled to the frame between the drive wheels and the rear wheel.

3. The zero-turn utility vehicle of claim 1, wherein the tool attachment is coupled to the frame forward of the drive wheels.

4. The zero-turn utility vehicle of claim 1, wherein the tool attachment is one of a mowing deck, a single-stage snowthrower, a two-stage snowthrower, a rotary broom, a lift bucket, or a dozer blade.

5. The zero-turn utility vehicle of claim 1, wherein the tool attachment is coupled to the frame via a mounting mechanism configured to transfer power from the prime mover to the tool attachment.

6. The zero-turn utility vehicle of claim 5, wherein the mounting mechanism comprises a telescoping universal joint.

7. The zero-turn utility vehicle of claim 1, wherein the user controls comprise a pair of levers, each lever being coupled to the drive mechanism of one of the drive wheels and configured to control the rotational speed of the drive wheel via the drive mechanism.

8. The zero-turn utility vehicle of claim 7, wherein the levers are coupled to the drive mechanisms with a drive-by-wire system.

9. The zero-turn utility vehicle of claim 1, wherein the user controls comprise a handlebar mechanism rotatable about an axis from a neutral position into a first rotation zone and a second rotation zone, and a controller receiving an input from the handlebar mechanism, the controller coupled to the drive wheels;
wherein the controller directs the drive wheels to rotate such that the vehicle turns about a point outboard from the first drive wheel when the handlebar mechanism is in the first rotation zone; and
wherein the controller directs the drive wheels to rotate such that the vehicle turns about a point between the first drive wheel and the second drive wheel when the handlebar mechanism is in the second rotation zone.

10. The zero-turn utility vehicle of claim 1, wherein the seat is fixed in a single orientation.

11. The zero-turn utility vehicle of claim 1, further comprising:
a counterweight coupled to the frame and movable forward or rearward to adjust the center of gravity of the vehicle.

12. A zero-turn utility vehicle, comprising:
a frame having a front end, a rear end, a right side, and a left side;
a pair of drive wheels disposed proximate to the front end of the frame, each drive wheel having a drive mechanism, the first drive wheel located on the left side of the frame and the second drive wheel located on the right side of the frame;
a rear wheel disposed proximate to the rear end of the frame;
a prime mover supported by the frame above the drive wheels, the prime mover configured to power the drive wheels via the drive mechanisms;
a seat supported by the frame, the seat disposed between the prime mover and the rear end, the seat fixed in a single orientation to support a user facing towards the front end in a normal operating position;
a front mount located proximate the front end and forward of the drive wheels, the front mount configured to receive a tool attachment to be powered by the prime mover;
a mid mount located between the drive wheels and the rear wheel and rearward of the prime mover, the mid mount configured to receive the tool attachment; and
user controls configured to operate the drive wheels, wherein the user faces the user controls in the normal operating position;
wherein each of the drive wheels may be operated independently with the user controls.

13. The zero-turn utility vehicle of claim 12, further comprising:
the tool attachment coupled to the frame mount.

14. The zero-turn utility vehicle of claim 12, further comprising:
the tool attachment coupled to the mid mount.

15. The zero-turn utility vehicle of claim 12, wherein the tool attachment is one of a plurality of tool attachments including at least two of a mowing deck, a single-stage snowthrower, a two-stage snowthrower, a rotary broom, a lift bucket, and a dozer blade.

16. The zero-turn utility vehicle of claim 12, further comprising:
a counterweight coupled to the frame and movable forward or rearward to adjust the center of gravity of the vehicle.

17. The zero-turn utility vehicle of claim 12, wherein the user controls comprise a handlebar mechanism rotatable about an axis from a neutral position into a first rotation zone and a second rotation zone, and a controller receiving an input from the handlebar mechanism, the controller coupled to the drive wheels;
wherein the controller directs the drive wheels to rotate such that the vehicle turns about a point outboard from the first drive wheel when the handlebar mechanism is in the first rotation zone; and
wherein the controller directs the drive wheels to rotate such that the vehicle turns about a point between the first drive wheel and the second drive wheel when the handlebar mechanism is in the second rotation zone.

18. A zero-turn utility vehicle, comprising:
a frame having a first end and a second end;
two drive wheels disposed proximate to the first end of the frame;
a third wheel disposed proximate to the second end of the frame;
a prime mover supported proximate the first end of the frame, the prime mover configured to power the drive wheels;
a handlebar mechanism configured to operate the drive wheels, the handlebar mechanism rotatable about an axis from a neutral position into a first rotation zone and a second rotation zone; and
a controller receiving an input from the handlebar mechanism, the controller coupled to the drive wheels;
wherein the controller directs the drive wheels to rotate such that the vehicle turns about a point outboard from the first drive wheel when the handlebar mechanism is in the first rotation zone;
and wherein the controller directs the drive wheels to rotate such that the vehicle turns about a point between the first drive wheel and the second drive wheel when the handlebar mechanism is in the second rotation zone.

19. The zero-turn utility vehicle of claim 18, wherein the controller directs the drive wheels to rotate such that the vehicle travels in a generally straight line when the handlebar mechanism is in the neutral position.

20. The zero-turn utility vehicle of claim 19, further comprising a detent at the neutral position to indicate when the handlebar mechanism is at the neutral position.

21. The zero-turn utility vehicle of claim 20, wherein the first rotation zone comprises a 10 degree arc from the neutral position of the handlebar mechanism.

22. The zero-turn utility vehicle of claim 21, further comprising a second detent between the first rotation zone and the second rotation zone to indicate when the handlebar mechanism moves between the first rotation zone and the second rotation zone.
